(19) United States
(12) Patent Application Publication
(10) Pub. No.: US 2006/0057285 A1
(43) Pub. Date: Mar. 16, 2006

(54) Decorative plaster sculpture kit and process

(76) Inventor: Joseph Vivirito, Valencia, PA (US)

Correspondence Address: JOSEPH VIVIRITO, 194 LOGAN ROAD, VALENCIA, PA, 16059, US

(21) Appl. No.: 10/939,143

(22) Filed: Sep. 10, 2004

(51) Int. Cl. B05D 5/00

(52) U.S. Cl. 427/198; 428/914

(57) ABSTRACT

A method and kit of materials for building a wall sculpture. The kit of materials includes all the necessary components to build a wall sculpture. The method utilizes the kit materials, starting with attachment of plastic tubing to a surface, such as a wall, to start the formation of a vine stem, then attaching the large copper wire to a surface, followed by the medium wire adjacent the plastic tubing to form a natural looking vine. Next, attach a solid plaster grape bunch or leaf appliqué to the wall near the vine. A stem is attached therebetween to connect the solid plaster grape or leaf bunch appliqué to the vine stem. The sculpture will cover any size surface and is adaptable to any specific situation, such as the exact shape or direction of where the vine “crawls” on the wall. It can be installed around a window, door, or picture frame, etc.

### BACKGROUND OF THE INVENTION

1. Field of the Invention

A method which enables consumers to install a beautiful “old-style craftsmanship” wall sculpture in their home or business.

2. Background Art

Wall art dates back to the first cave paintings in 8000 B.C. Later, sculpture was often found atop tapestries, paintings, doorways, windows, and on walls. However, it took a gifted artist to create these sculptures. The process/technique of the present invention allows installation of a wall sculpture, hereto impractical for the average consumer. With this invention, an average consumer can create their own wall sculpture.

### SUMMARY OF THE INVENTION

The present invention is a method and kit of materials for building a wall sculpture. The kit of materials includes all the necessary components to build a wall sculpture, for example, a grapevine, ivy or various other designs. The kit has molding plaster in the form of individual solid plaster grape bunch and leaf appliqués, small plastic tubing, large plastic tubing, small gauge copper wire, medium gauge copper wire, large gauge copper wire, construction adhesive, trim nails. The method utilizes the kit materials, starting with attachment of the plastic tubing to a surface, such as a wall, to form a vine stem, then attaching the large copper wire to the surface followed by the medium wire adjacent the plastic tubing to form a natural-looking vine. Next, attach a solid plaster grape bunch or leaf appliqué to the wall near the vine. A stem is attached to connect the solid plaster grape or leaf appliqué to the vine stem. The sculpture will cover any size surface and is adaptable to any specific situation, such as the exact shape or direction of where the vine “crawls” on the wall. It can be installed around a window, door, picture frame or the like.

### BRIEF DESCRIPTION OF THE DRAWINGS

FIG. 1 is a photograph of a portion of a grapevine wall sculpture of the invention;

FIG. 2 is an enlarged photograph of a portion of the grapevine wall sculpture of FIG. 1;

FIG. 3 is a further enlarged photograph of a portion of the grapevine wall sculpture of FIG. 1;

FIG. 4 is a photograph of an ivy wall sculpture; and

FIG. 5 is an enlarged photograph of a portion of the ivy wall sculpture of FIG. 4.

### DETAILED DESCRIPTION OF THE INVENTION

The present invention will be described with reference to the accompanying figures where like reference numbers correspond to like elements. The following detailed description includes words such as “large,” “small,” “medium,” “top,” and “bottom.” It is to be understood that these words are used in connection with the various views and embodiments of the present invention shown in the figures and are not to be construed as limiting the invention.

The invention is a method to create a wall sculpture out of materials in an accompanying kit. The materials consist of molding plaster in the form of individual solid plaster appliqués; various gauges of plastic tubing; various gauges of copper wire; construction adhesive; trim nails. The method describes a process whereby the finished combination of these materials makes it possible to achieve an unmatched strength, detail, and beauty that is created in this sculpture. The sculpture will cover approximately six linear feet of wall surface. However, the sculpture is designed to be able to adapt to any specific situation, such as the exact shape or direction of where the vine “crawls” on the wall. For example, if it is to be installed around a window, door, or picture frame, etc., the shapes and sizes are not to be construed as limiting the invention, since any suitable shape that forms a sculpture can be used under this technique.

The kit includes hand sculpted individual plaster appliqués. Sculpted out of sculptor's clay, the different bunches of grapes, and the various sizes and shapes of grape leaves are designed and sculpted from scratch, as are leaves and flowers of the various other designs. Then, a latex-rubber mold of all the individual clay sculptures is made. After that, a liquid mixture of molding plaster and water is poured into the mold and hardened to form all the detailed plaster appliqués to include in the kit.

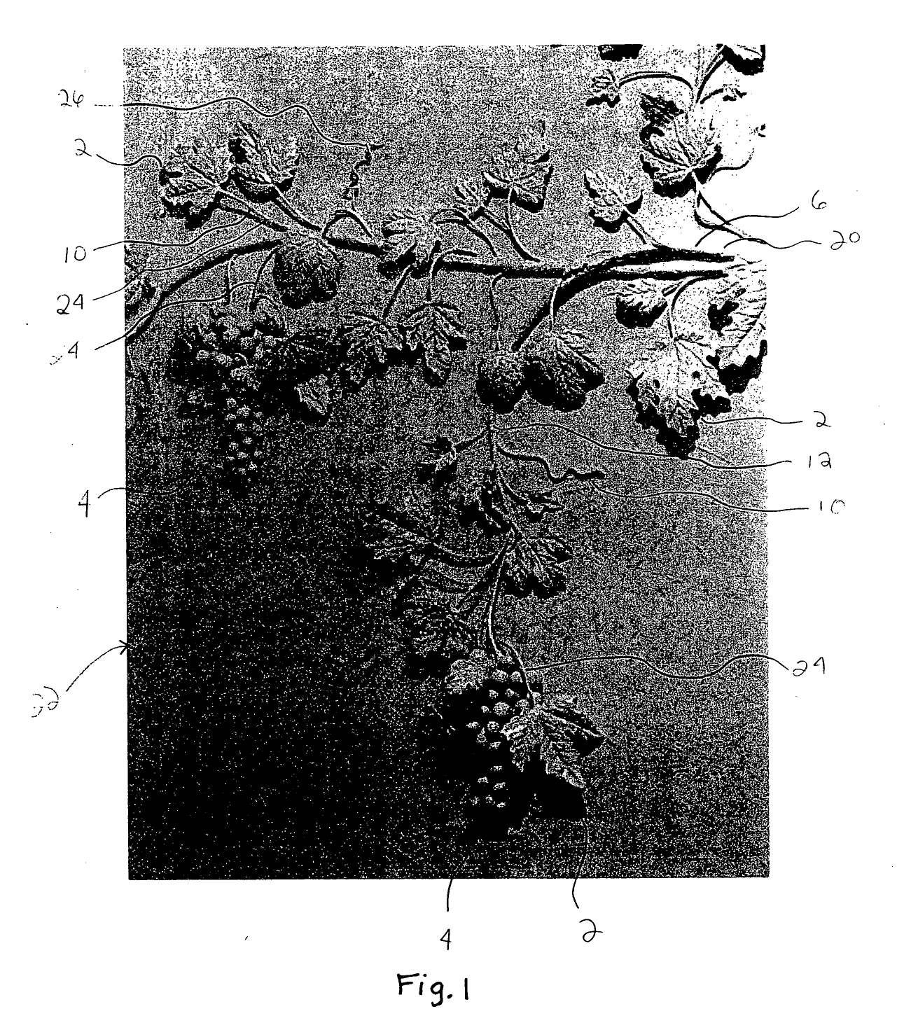

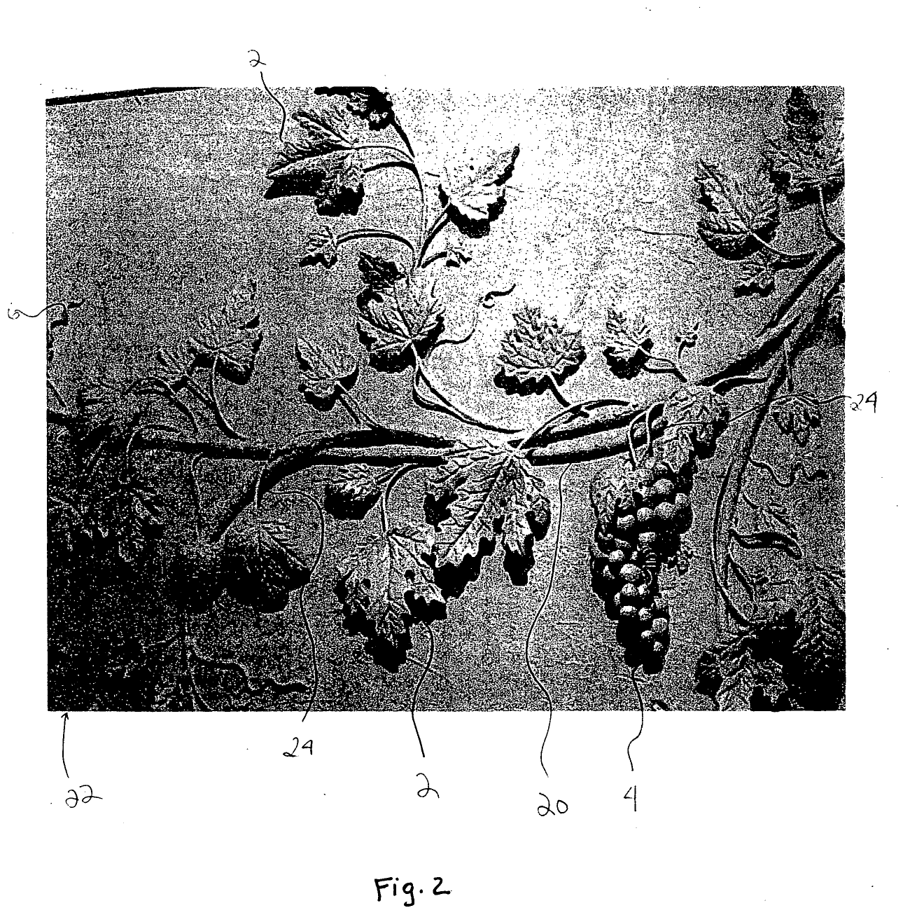

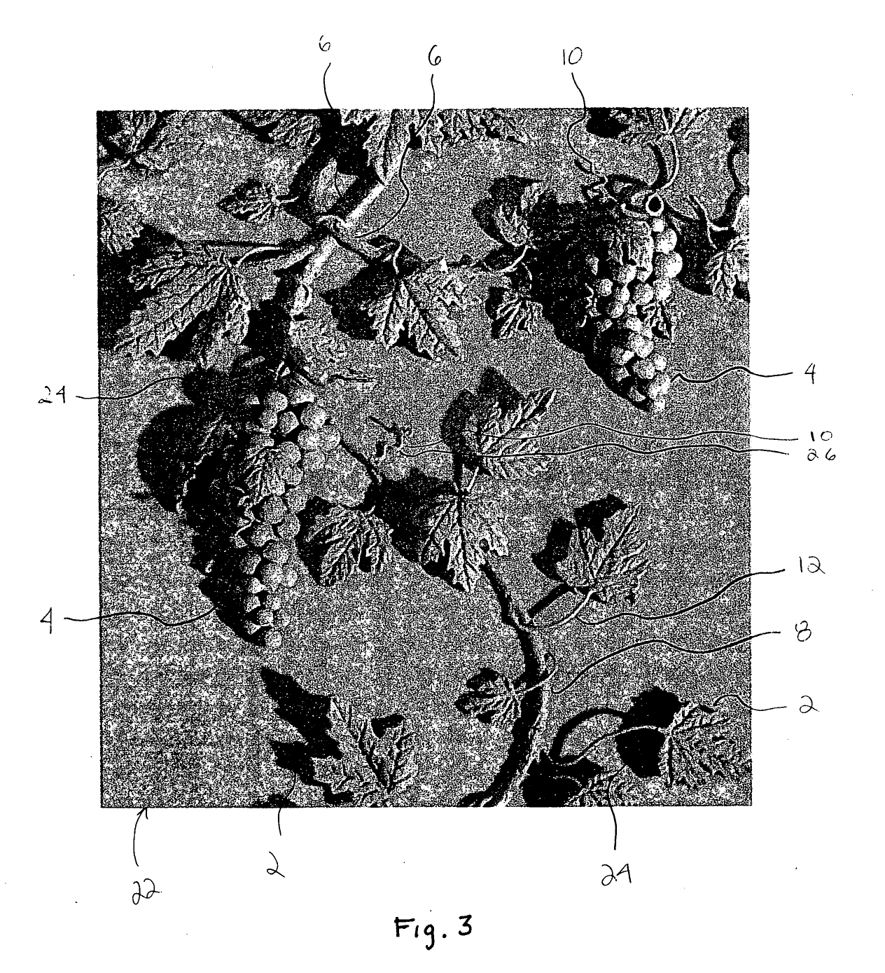

With reference to FIGS. 1, 2, and 3, the first step is attaching a main vine 20 to a wall 22. Starting from a point on wall 22 where main vine 20 is to “crawl” out from, a sketch is made. The beginning of main vine 20 will be a large plastic tubing 6, and it will taper down in thickness to a small plastic tubing 8 as it travels. To attach large plastic tubing 6 to wall 22, first squeeze a bead of a construction adhesive to the approximate length of the piece of large plastic tubing 6 onto wall 22, along the line drawing. Next, tack the large plastic tubing 6 to wall 22 aligned with the sketch and directly on the bead of glue using trim nails. Then, repeat the same process to attach the thinner small plastic tubing 8 to wall 22, continuing it right out from where large plastic tubing 8 left off. There are many ways to utilize large plastic tubing 6 and small plastic tubing 8 in coordination, such as direction or curves, just like a natural vine travels.

In the second step, main vine 20 is attached to a large copper wire 14 right where small plastic tubing 8 stopped. Using a pair of needle-nose pliers, or two pairs if needed, bend and curl large copper wire 14 to create a natural look. The bends and curls make the vine look as if it is “floating” off wall 22 in some points to create more of a three-dimensional detail. Large copper wire 14 is glued to wall 22 using construction adhesive. Repeat this step using the thinner medium copper wire 12, connecting in the same manner starting where the thicker large copper wire 14 ended, to complete the main vine 20.

Reducing the gauge of plastic tubing and copper wire as the vine comes to its end creates the look of the main vine tapering down in size as it “crawls” on wall 22.

In order to stop the tendency of glue to squeeze out from behind the plastic tubing and copper wire, smear it behind the plastic tubing and copper wire, thus ensuring a tight bond between the plastic tubing/copper wire and wall 22. Then take the excess adhesive and spread it all over the tubing and wire to create a textured vine look. This creates the illusion that main vine 20 is a natural vine and also facilitates the hiding of nails and transitions between pieces of plastic tubing and copper wire.

In the third step, attach an individual solid plaster grape bunch appliqué 4 to wall 22 using construction adhesive. First, choose a spot on main vine 20 to place solid plaster grape bunch appliqué 4. Apply adhesive all over the back of solid plaster grape bunch appliqué 4. Then, position solid plaster grape bunch appliqué 4 on wall 22 applying some pressure to ensure complete adhesion and a tight bond.

Next, to keep solid plaster grape bunch appliqué 4 in place until the adhesive dries, tack a trim nail into wall 22 tight to the bottom to keep it from sliding off. Later, when the adhesive is dry, the nail is removed.

Step four involves attaching solid plaster leaf appliqués 2 to wall 22. Attach solid plaster leaf appliqués 2, one at a time, to wall 22 with the construction adhesive, using the same method as with plaster grape bunch appliqué 4. First, applying adhesive all over the back of solid plaster leaf appliqué 2, placing it on wall 22, and ensuring solid plaster leaf appliqué 2 is facing in a direction that looks natural. In this step, to place the leaf in a natural position, the stem placement must be anticipated since the stems are attached after the leaves are in place. The number of solid plaster leaf appliqués 2 or solid plaster grape bunch appliqués 4 is only limited by the space available on wall 20 and is not to be construed as limiting the invention.

With continuing reference to FIGS. 1, 2, and 3, engage the solid plaster grape bunch appliqué 4 and solid plaster leaf appliqués 2 to main vine 20 with a stem 24. Stem 24 is made of small copper wire 10. For another stem 24, medium copper wire 12 is used. The size of the leaf dictates whether to use small copper wire 10 or medium copper wire 12. For example, use medium copper wire 12 adjacent the larger solid plaster leaf appliqués 2, and small copper wire 10 adjacent smaller solid plaster leaf appliqués 2. Take two pairs of needle-nose pliers, one in each hand, hold a piece of small copper wire 10 or medium copper wire 12 up to a solid plaster leaf appliqué 2 or solid plaster grape bunch appliqué 4, bending the wire to make it look natural from the vine to the leaf, and cut it to length. Now, using construction adhesive, attach it to both the leaf and the vine, smearing any excess onto the leaf and vine to provide strength and to make it look real. Continue this step until all solid plaster grape bunch appliqués 4 and solid plaster leaf appliqués 2 are engaged with stems 24. Also, bend and twist small copper wire 10 or medium copper wire 12 into a curled sprig 26. Each curled sprig 26 is of various shape and size and attached interposed to main vine 20. Place curled sprig 26 wherever it looks natural, especially out of solid plaster grape bunch appliqués 4.

After the adhesive is dry, the installer may elect to apply a primer and paint. First, prime the entire sculpture using a paintbrush, apply behind every little detail of the sculpture making sure not to miss a spot. This not only gives it complete coverage, it also tests the strength of the details in the sculpture. The same process is repeated to apply the paint, always paint the sculpture the same color as wall 22; later paint a little color onto the design. Once the paint is dry, the sculpture is finished.

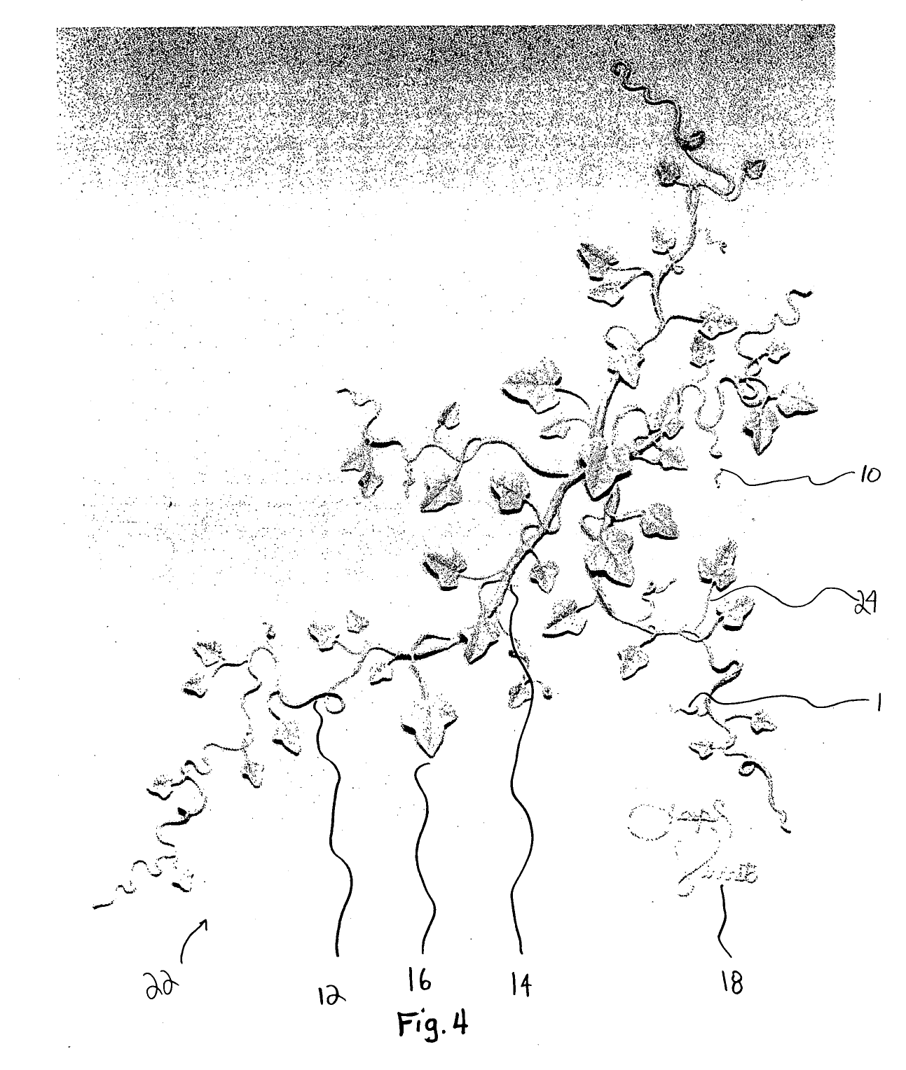

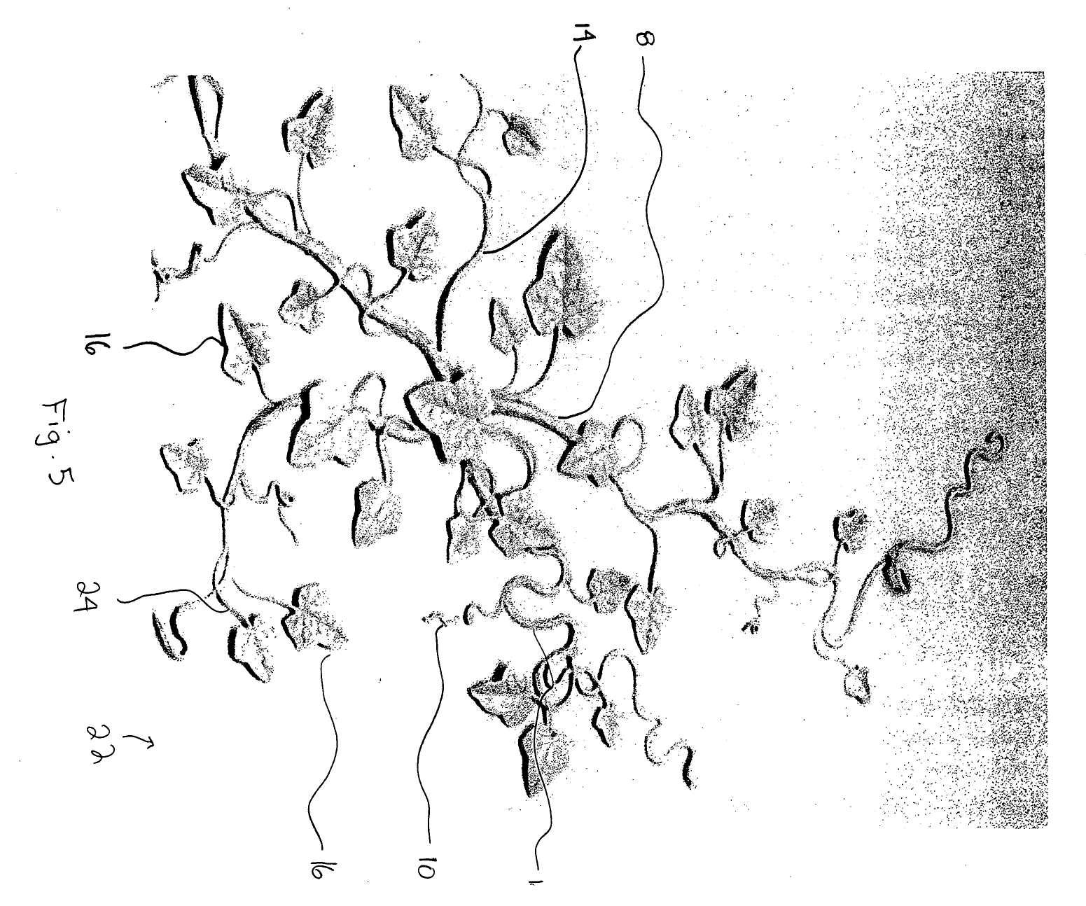

The size of the grapevine sculpture is not to be construed as limiting. It is designed to be able to custom “fit” to any size or pattern. Also, the style is not meant to limit the invention, other sculptures use the same materials and sculpting process/technique, such as many styles of ivy, for example, English ivy in FIGS. 4 and 5, roses, wildflowers, and different foliage, etc. The materials and process/technique works the same with them all.

The present invention has been described with reference to the preferred embodiments. Obvious modifications and alterations will occur to others upon reading and understanding the preceding detailed description. For example, the solid plaster leaf appliqué in the preferred embodiment is made from plaster; however, the leaf appliqué may be made from any material that is desired. It is intended that the invention be construed as including all such modifications and alterations insofar as they come within the scope of the appended claims or the equivalents thereof.

What is claimed is:

1. A method of building a sculpture from a kit of materials, wherein the method comprises:
creating an appliqué;
attaching the plastic tubing to a surface to form a vine stem;
attaching the large copper wire to the surface;
attaching the appliqué to the surface;
attaching a stem to connect the solid plaster grape bunch appliqué and the solid plaster leaf appliqué to the vine stem; and
applying a primer and paint to the sculpture.

2. The method as set forth in claim 1, wherein the kit of materials is comprised of:
molding plaster in the form of individual solid plaster grape bunch appliqués;
molding plaster in the form of individual solid plaster leaf appliqués;
small plastic tubing;
large plastic tubing;
small gauge of copper wire;
medium gauge of copper wire;
large gauge of copper wire;
construction adhesive; and
trim nails.

3. The method as set forth in claim 1, wherein the appliqué is one of a solid plaster leaf appliqué, a solid plaster grape bunch appliqué, a solid plaster rose bunch appliqué, a solid plaster ivy leaf appliqué.
